(19) United States
(12) Patent Application Publication
(10) Pub. No.: US 2010/0153259 A1
(43) Pub. Date: Jun. 17, 2010

(54) METHOD AND SYSTEM FOR ANALYSIS AND MANAGEMENT OF REAL ESTATE TRANSACTIONS

(75) Inventor: MARTIN REILLY STANTON, Silver Spring, MD (US)

Correspondence Address: Saul Ewing LLP (Baltimore);Attn: Patent Docket Clerk, Lockwood Place, 500 East Pratt Street, Suite 900, Baltimore, MD, 21202, US

(73) Assignee: STANTON ENTERPRISES, SILVER SPRING, MD (US)

(21) Appl. No.: 12/638,665

(22) Filed: Dec. 15, 2009

Related U.S. Application Data
(60) Provisional application No. 61/122,496, filed on Dec. 15, 2008.

(51) Int. Cl. G06Q 50/00; G06Q 40/00; G06Q 10/00; G06F 15/16

(52) U.S. Cl. 705/38; 705/316; 705/35; 705/400; 709/204

(57) ABSTRACT

A computer-implemented method for aggregating real estate transaction data prior to initiation of an application for financing to calculate a true cost associated with a completed real estate transaction comprising the creating of an integrator portal for real estate transaction data from a plurality of private and proprietary real estate resources; accessing a plurality of private and proprietary real estate resources by a server hosting said integrator portal; linking the real estate transaction data to the integrated portal in real-time; aggregating real estate cost data based on a pre-determined property input and a consumer specific background input; and calculating a true cost associated with the real estate transaction from cost data, wherein the cost associated with said transaction is delivered to a user.

### FIELD

The embodiments of the invention generally relate to a computer method and system for managing and analyzing real estate transactions, and, more particularly, to a method and system that provides a single platform, that generates accurate and simplified transaction information and a single interaction platform, to real estate professionals, mortgage professionals, title professionals and consumers.

### BACKGROUND

All aspects of the process of managing real estate transactions (buying, selling and refinancing) real estate generally involves a great deal of documentation. Most of the documentation involved requires redundant personal information and signatures of the parties. What is more, the financing involved in real estate transactions can include lengthy applications that often need to be completed more than once, if financing is being sought from more than one potential lender.

Currently, the majority of the real estate mortgage industry still uses very antiquated methods for preparing closing documents. The sale and financing of real estate has historically been associated with a great deal of paper documentation due to longstanding statutes and laws requiring written, signed and notarized documents for the legal transfer of land and to bind lenders and borrowers to the terms of fair loan agreements. Most often, typewriters or even word processors are used, but the completed documents are not stored electronically. Also, during the process of generating the necessary documents, much of the data is repeated throughout the documents. Such repetition wastes time and is prone to human error.

Currently, the industry does not provide for a simple single platform for assessing closing costs for consumers of real estate or even for those in the industry such as real estate professionals, mortgage professionals and title professionals (collectively referred to as “real estate professionals”). Fees on a mortgage cover almost every cost associated with getting a loan. Therefore, the true cost of purchasing real estate is not known until after closing. Additionally, the true cost of the product and risk of the product is not assessed or conveyed to consumers prior to closing. Conversely, the real estate professionals that are involved in any stage of the process do not have a comprehensive system conveying their risk in the transaction as well.

Fees that are paid at closing or settlement generally paid at 30 to 60 days after finalizing the sales contract. These closing costs are outlined in a “good faith estimate.” The Real Estate Settlement Procedures Act requires every bank or mortgage company to give the buyer the estimate within three days of applying for the loan. It will list expenses related to inspections, taxes, title insurance and a host of other charges. Also provided to the consumer by the bank is an information booklet, “Settlement Costs—a HUD Guide.” At that point, the bank provides the consumer with information on settlement costs and home buying. This is effectively an inverted purchase decision as compared to most other market decisions where a consumer has all true costs of the purchase available prior to closing. Typically, consumers at this point have already committed to the sizable purchase without adequately understanding the true costs and true risks of mortgage products.

Pre-purchase counseling was originally declared by HUD as being the preferred format. Mortgagee Letter 98-01 released in January of 1998 reprimanded the industry for allowing grossly inadequate homebuyer counseling in exchange for the mortgage insurance reduction. HUD warned that training must be provided in a classroom; face to face or electronic media format, and involve 15 to 20 hours of instruction to claim the premium discount. It is argued that the industry does not embrace pre-purchase counseling as it tends to undermine their control of the prospective homebuyer. By waiting until the client is obligated in an agreement to purchase a home, real estate agents prevent the possibility of losing a client as a result of information provided to them in homebuyer counseling sessions. Typically, only after purchasing a home, is the buyer referred to a counseling program to claim the FHA insurance discount. While this defeats the purpose of educating them, it may well be that pre-closing as opposed to actual pre-purchase counseling is the best voluntary level of compliance that HUD can get from the present real estate industry.

Due to this inverted approach to real estate transactions as compared to other market segments, the consumer is also unable to truly compare all real estate purchase options with the true costs for the purchase and relative risks associated with various financing vehicles. U.S. Pat. No. 7,016,866, incorporated herein by reference in its entirety teaches an invention that serves as a single point of contact for various parties in a real estate transaction in accessing real estate tools and services. U.S. Pat. No. 5,414,621, incorporated herein by reference in its entirety teaches the use of assessment percentages and sales data of comparable properties to determine the value of a subject property.

Therefore there is a continuing unmet need for an improved method for assessing true cost to the real estate transaction process at the beginning of the process rather than after purchase decisions and commitments have been made.

### SUMMARY

In view of the foregoing, the invention provides a technology platform that provides the regulatory answers and business solutions, and provides a consumer with choices to shop for a mortgage, greater certainty to closing costs, and a simplified and improved mortgage origination and closing process.

The present invention provides for a computer implemented method which includes an education module which provides for a consumer focused interactive audio/visual presentation and explanation of the home buying and selling process, including refinance and reserves and reverse mortgage transactions, and the real estate contract, mortgage and title documents; a bottom line module which is an automated software tool that will provide accurate assessment for buyers and sellers of exact real-estate transaction closing costs and will enable consumers to make informed decisions about providers and actively alter scenarios, saving them for future reference and comparison; a tax module which includes an automated software tool that will provide accurate real property tax assessments, accurate assessments of the transfer and recordation taxes, and up-to-date local tax information for properties subject to escrow accounts; a risk module which comprises a software utility that can provide accurate risk assessments of the mortgage products used in residential real estate transaction and can be used by consumers and real estate professionals with an easy to understand comparison of risks; and a livedoc module which includes an electronic document repository used to save prospective transaction scenarios when shopping for a home or mortgage, and a long-term for the actual closing documents accessible by the consumer and the affected professional.

It is an aspect of a computer-implemented method for aggregating real estate transaction data prior to initiation of an application for financing to calculate a true cost associated with a completed real estate transaction comprising: creating an integrator portal for real estate transaction data from a plurality of private and proprietary real estate resources; accessing the plurality of private and proprietary real estate resources by a server hosting the integrator portal; linking the real estate transaction data to the integrated portal in real-time; aggregating real estate cost data based on a pre-determined property input and a consumer specific background input; and calculating a true cost associated with the real estate transaction from the cost data, wherein the cost associated with the transaction is delivered to a user.

It is an aspect of the embodiments disclosed herein to provide the tools necessary for consumers, mortgage bankers, mortgage brokers, realtors, and title professionals to have an accurate cost of the transaction before the offer is given or received, before the application is taken, before a loan product is chosen, and before a title order is made. The invention establishes the finish line before the process begins in order to achieve a successful outcome, i.e. home ownership. The invention to provide consumers the guidance and analyzed information early in the home purchase process about different loan products and to generate outcome matrices based on inputted and complied real estate, lending, transaction and other relevant data as are known to those of skill in the art.

It is a further aspect of the invention to provide an automated script which walks consumers through different choices of loan products and will alert them to what financial vehicles are conservative, moderate, and aggressive so consumers can make informed decisions prior to entering into a contract or making a loan application.

Accordingly, it is an aspect of the invention to provide for promoting the consumer's choice to shop for a mortgage, bringing greater certainty to closing costs, and to simplify and improve the mortgage origination and closing process.

It is a further aspect of the invention to provide for real time rates and payoff information for mortgage products.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a flow diagram of a conventional real estate transaction process and timing.

FIG. 2 illustrates is a flow diagram of the modules of the method and system disclosed herein.

FIG. 3 illustrates a flow diagram of the method.

FIG. 4 shows a diagram of an IP network, which is an example of one type of flow-based network in which the technique of the present may be implemented.

FIG. 5 illustrates the relationship of subnetworks and gateways to layered protocols.

FIG. 6 is a block diagram of a network system comprising a collection of computer networks connected to a plurality of node.

FIGS. 7A and 7B illustrate a computer system suitable for implementing embodiments of the present invention.

FIGS. 8A-J describe the system architecture and relationship diagram of each module and data or information portal or node of the invention.

### DETAILED DESCRIPTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

In one embodiment, the invention provides for a computer-implemented method for aggregating real estate transaction costs prior to initiation of an application for financing to calculate an end of transaction true cost which is the total cost associated with a completed real estate transaction comprising: creating an integrator portal for real estate transaction data from a plurality of private and proprietary real estate resources; accessing the plurality of private and proprietary real estate resources by a server hosting the integrator portal; linking the real estate transaction data to the integrated portal in real-time; aggregating real estate cost data based on a pre-determined property input and a specific consumer background input; and calculating a true cost associated with the real estate transaction from the cost data, wherein the cost associated with the transaction is delivered to a user and wherein the method coheres transaction data. The specific background input can be specific to the consumer interested in a transaction which can include but is not limited to property address, tax information, income and other assets, first-time home buyer status or other demographic information as are known to one of skill in the art. The coherence step involves providing the user actionable intelligence relating to real-time actual total cost associated with a completed real-estate transaction whether the transaction is in progress or contemplated.

The present method further comprising admitting said user to said integrator portal providing the user real time access to the integrator portal. The user can be selected from various individuals and entities including but not limited to consumers, real estate professionals, title professionals and mortgage professionals. The plurality of private and proprietary real estate resources that can be accessed using the present method may comprise lender organizations, banker organizations, settlement organizations; title companies; appraisers; regulatory and legislative databases; real estate listing aggregators, among others that are known in the art.

The system of the present invention provides for a single facilitator of the transaction. The user can pick a real estate agent, mortgage professional, and title professional and use their services via a single aggregator portal. The real estate broker module provides the consumer with the ability to read through and draft the offer and submit it through their buyer broker to the listing broker representing the seller. The seller may counter the offer or ratify it and send it back via the portal. Upon ratification the purchaser's earnest money can be deposited into an escrow account through the platform and any of the real estate professionals can hold it. All of the necessary mortgage and title documents can be sent and received in the same manner.

A computer system for aggregating real estate transaction costs prior to initiation of an application for financing to calculate a true cost associated with a completed real estate transaction comprising: an integrator adapted to collecting real estate transaction data from a plurality of private and proprietary real estate resources; accessor module for interconnecting said plurality of private and proprietary real estate resources with a server hosting said integrator; an aggregator adapted to selectively compile real estate cost data based on a pre-determined property input and a consumer specific background input; and a calculator adapted to compute a true cost associated with the real estate transaction from said cost data, and a graphic user interface adapted to deliver real estate transaction information to a user. The complete system of the invention may include a desktop workstation, a personal computer, or a server. The system can be accessed remotely via internet, WIFI, or other means as are known in the art. The system may also be accessed via a computer, personal data assistant, small phone, or other mobile devices as are known in the art.

The invention coheres disparate sources of data to provide for consistent and actual settlement charges needed to purchase property of choice real time at any point of the transaction, and education with audio/visual of the settlement statement. A document which is now only seen at the settlement table the consumer can receive a complete explanation of the document with real time accurate figures. The consumer can have the ability to interact with settlement statement. A purchaser can compare settlement statements side by side in order to make informed decision regarding fees. An example of this would be the purchaser weighing the benefits of paying points to lower the interest rate for a savings monthly but more money needed on the day of settlement or having the lender credit points to have less due at settlement but more money spent monthly. A seller can compare settlement statements side by side to make informed decisions regarding fees. An example of this would be the seller comparing commission schedules based on selling property themselves (FSBO), Discount Brokerages (SAVE SIX®), Internet Brokerages (REDFIN®), and Full Service Brokerage (e.g. REMAX®).

The system as document repository also provides all of the forms and legal documents used in any transaction and all versions can be stored in a file which the consumer and real estate professionals can access in real time with proper security provided by the software, including but not limited to: for real estate brokers the agency agreement and contract of sale; for mortgage professionals the rate lock agreement, truth in lending, and good faith estimate; and for title professionals the title abstract, title policy, and settlement statement.

The system and escrow account also provide for all funds for earnest money deposit, credit report and appraisal, and cash needed for settlement can be wired in or out if account. The system also provides an advantage as a technology enhancer and paper reducer. The paper files can be replaced with real time files stored on the system. After settlement the only person with access to the file would be the consumer. This will allow for more e-closings (i.e. electronic closings), real estate, and mortgages.

The system also provides for a live document (“LiveDoc”). A LiveDoc as used herein provides for automated messaging and alert to a user, e.g. consumer, alerting them if their adjustable rate mortgage is about to adjust. The system stores historical information regarding previous transactions, analyzes the historical data and periodically can send a message to the alert a used, e.g. consumer or real estate professional, of certain milestones in the life cycle of the transaction such as, by way of example not limitation, adjustment of an adjustable rate mortgage or, periodically, based on previous user income data, amounts necessary to pay off a loan. Data analyzed include payment history of the consumer (including regularity of payment or principal payments), estimated salary over time, or regional market trends, by way of example not limitation, in order to send appropriate notices. The LiveDoc can follow the consumer through life of purchasing first home, second home, etc. Each time the consumer elects a new transaction they can go back to the present invention for all of the aforementioned information and the process will start over again. Bottom Line module can be used by seller and automatically put in to the cash to close or also referred to as closing module in purchasing a new property. The closing module calculates the amount required prior to closing for settlement during the purchase of real property. The system can also provide information about loan products and tax information when borrower based on their profile. It can provide a no hassle educational text and/or video-audio of reverse mortgages and using the tax module it will show property tax discounts for seniors.

In another embodiment, the present invention provides for identification of a specific transaction and professionals within it through an identifier whereby industry and/or government can use the information operating in the industry.

The invention provides audio and/or visual and/or text of loan documents prior to closing with all relevant financial information upon identification of a relevant piece of property so that closing costs and actual costs over time are calculated by aggregating information from various sources. Typically, these documents and information are now only provided at the settlement table and accuracy of information is subject to human input errors. These documents with the present invention can be accurately generated and reviewed at the very beginning or at any point in the process. The invention further provides for a complete explanation of all information in the process. Moreover, the invention provides for interactive loan documents. The system further provides for compiling loan program information, analyzing the loan programs based on consumer, tax, closing and other relevant data and providing comparatives of most favorable loan programs side by side. An example of this would be the purchaser comparing a thirty-year fixed rate, a 5/1 adjustable rate mortgage (ARM), and a one-year ARM. The invention provides for a risk module module which is an algorithm used to measure the riskiest features of the mortgage product and will disclose the information to the purchaser in different shades of color and by stating the risk level. The system can graphically display the risk level where the symbol can show the relative risk level, for example, Green=Conservative, Yellow=Moderate, and Red=Aggressive, by way of example and not limitation. The risk module further makes a recommendation based on the compiled data by determining risk of default. A seller can compare payoff information in real time to make informed decisions. Rather than receiving only an “estimated net sheet” at the time a listing is signed the seller can use the system to order accurate payoff information and deal with any discrepancies and ask any questions at any time during or even before the process.

The invention also provides for compelling and presenting at any point in the process real time tax information. The information can be presented as education with audio visual and/or text of important tax information. The tax information will also be included in the closing documents generated for the buyer of the property and can be integrated into the LiveDoc for ongoing tax information to be delivered. Transfer taxes, Recordation taxes, and property taxes can be documented clearly and adjusted correctly in real time. The system provides for interactive tax bill information. The use of the tax module will allow data listed on the county and state web sites to be retrieved and inputted properly for the adjustments, the escrow, and the transfer and recordation tax sections of the settlement statement. The system delivers the current tax bill and assesses and provides what it will be when the first bill arrives once a consumer purchases the property and calculates any possible credits or reductions due thereafter.

Rather than relying on the taxes provided by the listing agent in the Multiple Listing Service as is typical, the system calculates the current tax bill what it is now and whether it was paid and adjustments will be made automatically on the settlement statement, a purchaser can see current credits reducing or increasing tax bill, and be provided with information in the area the property is located how said tax bill can be reduced such as the homestead credit. For the seller the system provides what the current tax bill is and what money is owed by him or to him based on when the bill was previously paid or if it is currently due directly affecting the bottom line the seller will receive at settlement in real time.

The invention also provides the real estate professional with accurate settlement charges in real time from the very beginning of the process. Fees charged consumer for services rendered can be accurately reflected on the settlement statement. A real estate broker's commission and administrative fees due at settlement agreed to in the listing and buyer broker agreements can be entered or pulled into settlement statement at inception of agreement so there is no confusion. The current process of offering an estimated net sheet can be replaced or greatly enhanced with accurate data automatically populated into the document of choice. A mortgage professional can enter origination fees, points, among other charges due at settlement at the time of the loan application so there is no confusion. Current process of offering good faith estimate can be replaced or greatly enhanced with accurate data automatically populated into the document of choice. A title professional can enter title insurance premium, closing fee, among other charges due at settlement at the time of the title order so there is no confusion. The current process of offering an estimated settlement statement relying on third party fees can be replaced or greatly enhanced with accurate data from all professionals involved in the process automatically populated into the document of choice. The invention will aggregate each real estate professional profile of fees and pull relevant data from private proprietary sources to calculate accurate costs based on specific property, buyer and seller. Some items included but are not limited to commission data from multiple listing services, loan pricing based on lender program requirements on loan to value/credit scores and title insurance calculations based on regulatory requirements within a specific jurisdiction.

The invention further provides access to and use of most important documents in real time at any part of the process educational audio/visual and/or text of the documents as they pertain to each of the real estate professionals business.

The invention provides a portal for real estate brokers to offer broker agreements explaining fee and commission agreement with services rendered and a complete explanation of the contract of sale. An automated process will reduce potential risk for law suits regarding fair housing violations and non disclosure of material facts and educational tool for real estate agents in training. The invention provides access to mortgage professional notes, good faith estimates, and the truth in lending forms to meet delivery requirements and a complete explanation. An automated process will reduce risk for law suits regarding fair housing, community reinvestment, and regulation Z violations. The invention also provides access to title professional deeds, settlement agreement disclosures, and title binders to give accurate information before settlement. An automated process will reduce the risk of law suits regarding defects in title and mistakes in collection of fees at settlement.

Furthermore, the invention provides a single platform where accurate information exists and leads to successful transactions, which creates more business opportunities. The current process of communication between real estate professionals is arduous. The present invention provides a single point of access for: real estate broker data, including data regarding the contract, commissions, and customer information into one platform where it is instantly available to the mortgage and title professionals; mortgage professional data including initial terms of loan and any issues that may arise such as a low appraisal in real time with the real estate broker and title professional; and title professional data including initial status of title search and any defects that may arise as soon as it occurs with the real estate broker and mortgage professional.

The invention provides for a single platform where accurate information is compiled and cohered by accessing information from federal and state regulators to regulate, reduce cost, and provides the consumer or user with actual and consistent transaction information in real time. The current Regulatory process has been ineffective and costly. The invention provides an identification number for the transaction and each professional involved so industry and government can proactively audit transactions from their inception rather than reactively after legal action is brought against a real estate broker, a loan goes into default or a title claim is made against the title agent who performed the settlement. The invention provides for proper forms and accurate information for real estate professionals. Thus, the invention provides for, in real time, meeting the intention of Federal Statutes: Real Estate Settlement Procedures Act (RESPA), the Federal Truth In Lending Act (TILA), and Equal Credit Opportunity ACT (ECOA) as well as State statutes Home Owner's Association Act, Disclosure Laws, and the Wet Settlement Act.

Also aggregated by the invention, is accurate real property, transfer, and recordation tax data which will lead to fewer mistakes in the collection of revenue due and inefficiencies at the clerk's office where the property is located, whereby accurate information given in real time informs the consumer which in turn creates the fewest hassles which leads to a happy tax payer.

The invention provides lenders and investors in mortgage backed securities a single platform where accurate information is compiled to lead to more transparency in the process and better performing loans. The Current credit swaps and loan crisis was caused by a number of factors. Consumer's use of the risk module of the present invention and ability to compare different loan products in real time will lead to better choices and better performing loans. Accurate mortgage professionals information on a single platform can provide consumers confidence to begin borrowing again.

The tax module of the invention can lead to fewer surprises of increases in escrow accounts and inability to make mortgage payments which results in better performing loans.

Integration of internet real estate business entities into the single platform of the invention enhances their service to customers and clients and provides synergy created in services provided to consumers and real estate professionals. By way of example not limitation of such internet real estate entities aggregated into the platform provided by the invention is the Integration of Zillow's Zestimator® with the present invention which can provide the value of the home access to an accurate settlement statement in real-time. Then they can refer them to a real estate professional to assist them with various parts of the transaction.

It is a further embodiment of the invention to provide for real-time fees of changes to transaction costs or other related statistics to the transaction. Also provided are newsfeeds or RSS (Really Simple Syndication) feeds including social networking feeds such as those known in the art such as TWITTER, FACEBOOK, NING and others.

Provided herein is a computer program product for aggregating real estate transaction costs prior to initiation of an application for financing to calculate a true cost associated with a completed real estate transaction comprising: creating an integrator portal for real estate transaction data from a plurality of private and proprietary real estate resources; accessing said plurality of private and proprietary real estate resources by a server hosting said integrator portal; linking the real estate transaction data to said integrated portal in real-time; aggregating real estate cost data based on a pre-determined property input and a consumer specific background input; and calculating a true cost associated with the real estate transaction from said cost data, wherein the cost associated with said transaction is delivered to a user. The user can be admitted to said integrator portal in order to access real estate transaction data and information relating to closing costs and overall true costs of the transaction.

The system and method can provide the purchaser and seller with an accurate figure for settlement through the “cash to close module” or closing module and the “bottom line module” (BL). The present invention can give consumers, mortgage, real estate, and title professionals actionable intelligence to interact within one platform where they can give accurate information. They will take the current three step arduous process and converge it into one simple solution so their clients the consumer be confident of “no surprises at settlement.” They can focus on what they have always done best, providing access to the real estate market, giving competitive loans which fit their customer's needs, and insuring a successful transfer of title.

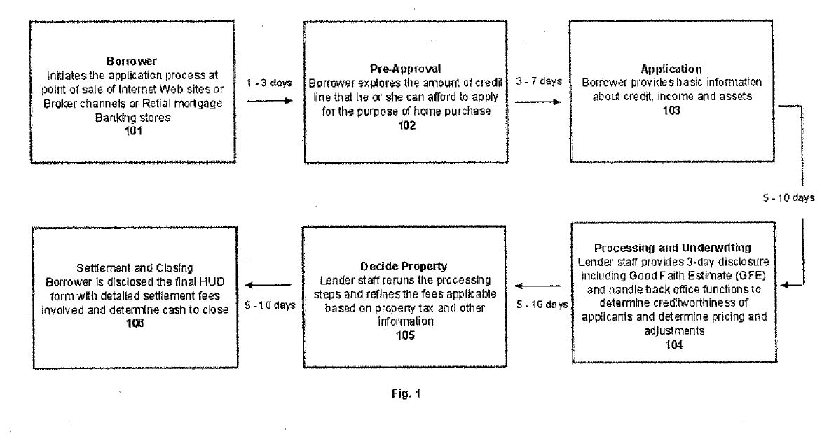

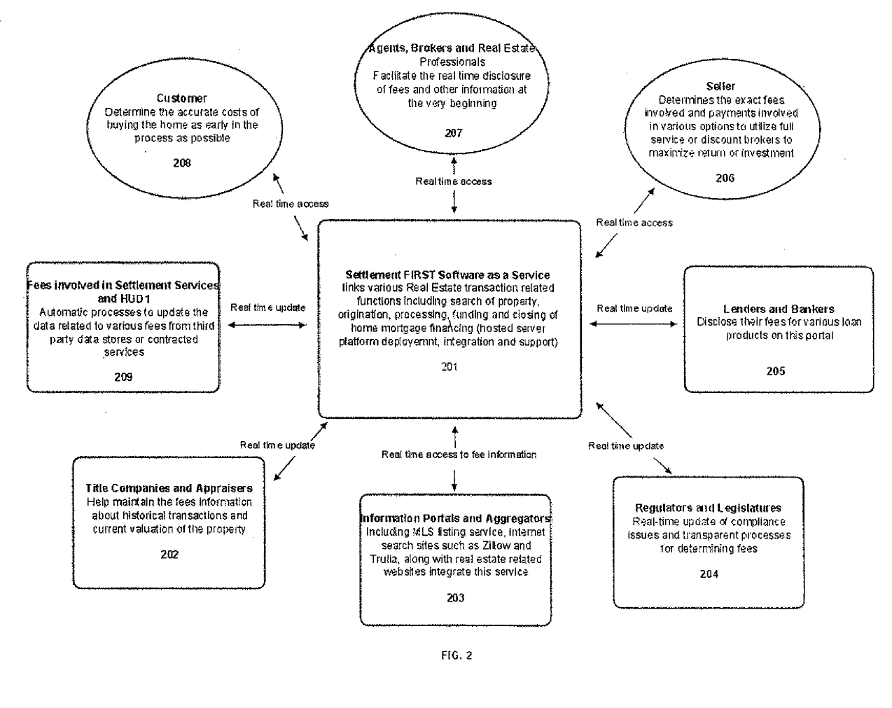

Referring now to the drawings, and more particularly to FIGS. 1 through 6, where reference characters denote corresponding features consistently throughout the figures, there is shown preferred embodiments of the invention.

FIG. 1 illustrates a flow diagram of a conventional real estate transaction process and timing. FIG. 1 illustrates a typical time line of a real estate transaction which begins after the purchase decision is made. The typical process begins with the consumer deciding to purchase real estate, making an offer, signing a contract, the borrower initiates the application process at a point of sale, internet web site, broker channels or retail mortgage banking stores 101. After about 1 to about 3 days, a pre-approval is issued where the borrower explores the amount of credit line that he can afford to apply for the purpose of home purchase 102. The application is filed based on basic information about 3 to about 7 days after pre-approval is granted 103. Processing and underwriting of the application commences about 3 to about 10 days there after 104. From about 5 to about 10 days after processing and underwriting, the specific property is included in the transaction whereby the lender staff reruns the processing steps and adjusts the applicable fees based on property tax and other property specific information 105. The final step in the process, commencing about 5 to about 10 days after adjustments to the calculations are made is settlement and closing 106, whereby the final HUD form is disclosed to the borrower, with detailed settlement fees involved and the cash required to close, the transaction is determined. It is an embodiment of the presenting invention to take the final step and begin the entire process with it using an integrated computer system to provide accurate real-time information to a consumer of real property.

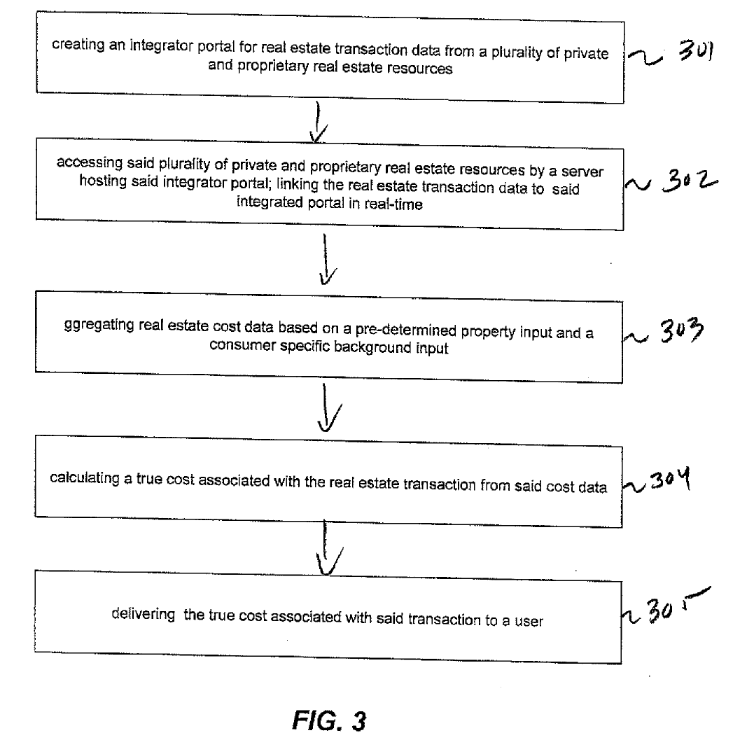

FIGS. 2 and 3 are flow diagrams illustrating the modules of the method and system disclosed herein. The system provides a hub or, alternately an integrator network, for various Real Estate transaction related functions including search of property, origination, processing, funding and closing of mortgage financing. It can be a server hosted platform as described in more detailed embodiments disclosed herein. The system provides for real-time updating of information from a plurality of real estate informational resources including but not limited to: title companies and appraisers 202, where the fee information regarding historical transactions and current valuation of the property is maintained; information portals and aggregators 203, including integrating search and informational capabilities from MLS listing services, internet sites such as ZILLOW and TRULIA and other public and private real estate related web-sites; regulatory and legislative information 204, where the system searches through federal and state government and private regulatory and legislative web-sites to compile compliance issues and transparent processes for determining fees; lenders and bankers 205, from which the method inquiries and compiles the fees for various loan products; settlement services fees 206, where the system automatically processes to update the data related to various fees from third party data stores or contracted services.

FIG. 2 further describes the users having real time access to the hub or integrator system of the invention which includes but are not limited to: customers, e.g. borrowers, where the software determines and delivers the accurate cost of buying the home as early in the process as possible (preferably upon identification of a piece of property of interest); agents, brokers and other real estate professionals, where the software can compile inputted fees and other information for delivery to the consumer or the agent, broker or other professional, on behalf of the consumer; and seller, where the system can determine the exact fees involved and payments involved in various options to utilize full service or discount brokers to maximize a return on investment.

FIG. 3 discloses a flow of an embodiment of the invention comprising: In one embodiment, the invention provides for a computer-implemented method for aggregating real estate transaction costs prior to initiation of an application for financing to calculate a true cost associated with a completed real estate transaction comprising: creating an integrator portal for real estate transaction data from a plurality of private and proprietary real estate resources 301; accessing the plurality of private and proprietary real estate resources by a server hosting the integrator portal 302; linking the real estate transaction data to the integrated portal in real-time; aggregating real estate cost data based on a pre-determined property input and a consumer specific background input 303; and calculating a true cost associated with the real estate transaction from the cost data, wherein the cost associated with the transaction is delivered to a user.

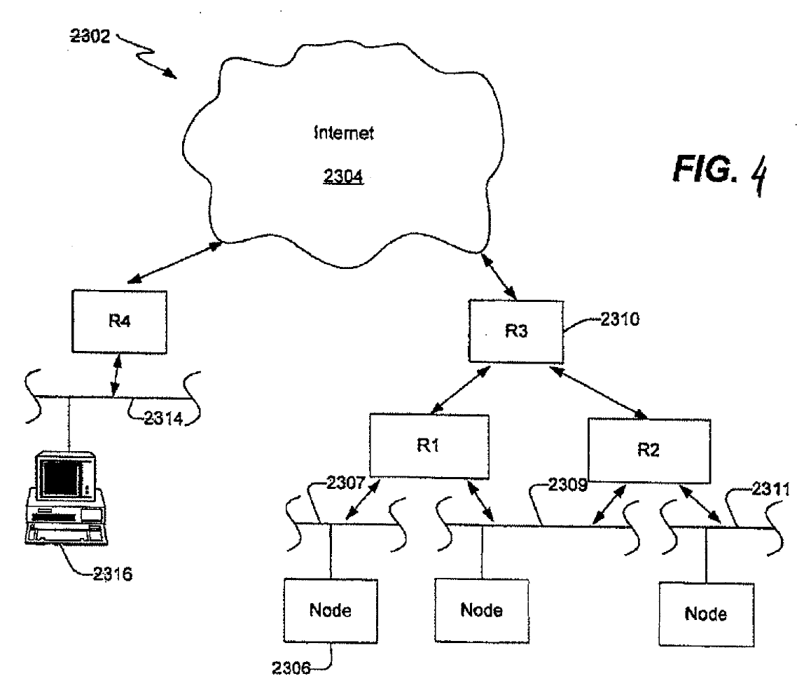

FIGS. 4-7 describe various systems and protocols for implementation of the invention disclosed herein. FIG. 4 shows a diagram of an IP network, which is an example of one type of flow-based network in which the technique of the present invention may be implemented. A flow can be a hard-state virtual circuit in an ATM network, a soft-state flow in an IP network (e.g., a MPLS tunnel), or a stateless connection as a TCP/IP connection in today's Internet. As shown in FIG. 23, the IP network 2302 includes the Internet (or a WAN) 2304 over which a Node 2316 (e.g. a computer) can communicate with a separate node 2306 via a plurality of intermediate nodes (e.g. R1, R3, R4). Node 2306 may be, for example, a server which is part of Local Area Network (LAN) 2307, connected to the Internet via routers R1 and R3. Router R3 (2310) may, in turn, connect one or more other routers (e.g., router R2) with the Internet.

A LAN is a communication network that serves users within a confined geographical area. It is made up of servers, workstations, a network operating system and a communications link. Servers are high-speed machines that hold programs and data shared by all network users. The workstations, or clients, are the users' personal computers, which perform stand-alone processing and access the network servers as required. The controlling software in a LAN is the network operating system, such as, for example, NetWare, UNIX, and/or Appletalk, which resides in the server. Message transfer is managed by a transport protocol such as, for example, IPX, SPX, SNA and/or TCP/IP. The physical transmission of data is performed by the access method (Ethernet, Token Ring, etc.) which is implemented in the network adapters that plug into the machines. The actual communications path is the cable (twisted pair, coax, optical fiber) that interconnects each network adapter.

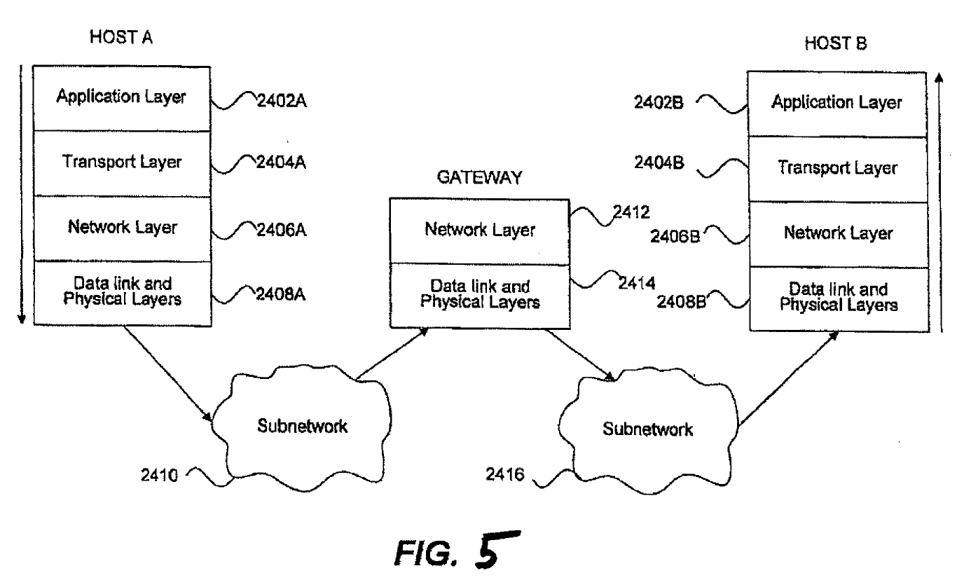

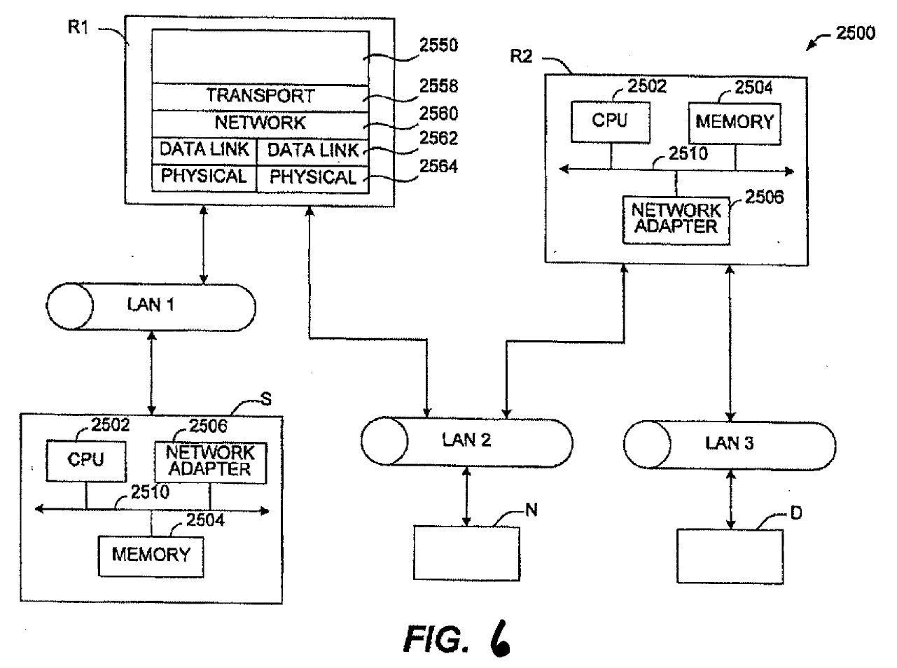

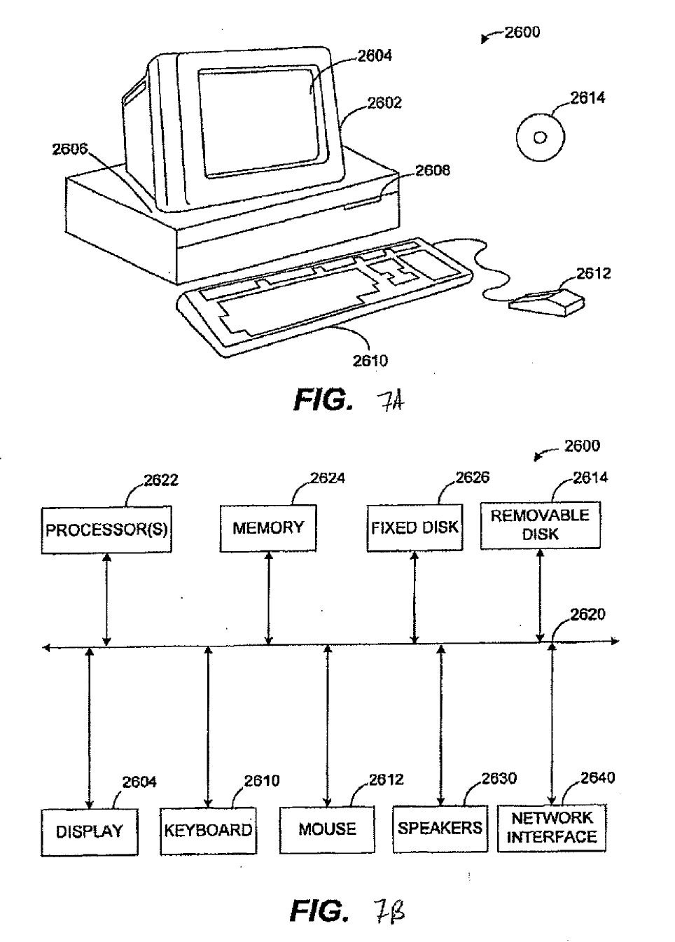

In order to reduce design complexity, most networks are organized as a series of hardware and software levels or “layers” within each node. These layers interact to format data for transfer between, e.g., a source node and a destination node communicating over the network. Specifically, predetermined services are performed on the data as it passes through each layer and the layers communicate with each other by means of the predefined protocols. This layered design permits each layer to offer selected services to other layers using a standardized interface that shields those layers from the details of actual implementation of the services. The layered protocols, commonly referred to as protocol stacks, are described in greater detail with reference to FIG. 5.

FIG. 5 illustrates the relationship of subnetworks and gateways to layered protocols. Assume that the user application 2402A in host A sends an application protocol data unit (PDU) to an application layer protocol 2402B in host B, such as, for example, a file transfer system. The file transfer software performs a variety of functions and sends file records to the user data. In many systems, the operations at host B are known as server operations and the operations at host A are known as client operations.

As indicated by the downward arrows in the protocol stack at host A, this unit is passed to the transport layer protocol 2404A, which performs a variety of operations and adds a header to the PDU passed to it. At this point, the unit of data is often referred to as a segment. The PDU from the upper layers is considered to be data to the transport layer.

Next, the transport layer passes the segment to the network layer 2406A, also called the IP layer, which again performs specific services and appends a header. This unit (now called a datagram in internet terms) is passed down to the lower layers. Here, the data link layer adds its header as well as a trailer, and the data unit (now called a frame) is launched into subnetwork 2410 by the physical layer 2408A. Of course, if host B sends data to host A, the process is reversed and the direction of the arrows is changed.

Internet protocols are typically unaware of what goes on inside the network. The network manager is free to manipulate and manage the PDU in any manner necessary. In some instances, however, the internet PDU (data and headers) remains unchanged as it is transmitted through the subnet. In FIG. 5, it emerges at the gateway where it is processed through the lower layers 2414 and passed to the IP (network) layer 2412. Here, routing decisions are made based on the destination address provided by the host computer.

After these routing decisions have been made, the PDU is passed to the communications link connected to the appropriate subnetwork (comprising the lower layers). The PDU is re-encapsulated into the data link layer frame and passed to the next subnetwork 2416, where it finally arrives at the destination host.

The destination (host B) receives the traffic through its lower layers and reverses the process that transpired at host A; it de-encapsulates the headers by stripping them off in the appropriate layer. The header is used by the layer to determine the actions it is to perform; the header therefore governs the layer's operations.

The PDU created by the file transfer application in the application service layer is passed to the file transfer application residing at host B. If host A and B are large mainframe computers, this application is likely an exact duplicate of the software at the transmitting host. The application might, however, perform a variety of functions, depending on the header it receives. It is conceivable that the data could be passed to another end-user application at host B, but in many instances the user at host A merely wants to obtain the services of a server protocol, such as a file transfer or e-mail. If this is the case, it is not necessary for an end-user application process to be invoked at host B.

To return the retrieved data from the server at host B to the client at host A, the process is reversed. The data is transferred down through the layers in the host B machine, through the network, through the gateway, to the next network, and up the layers of host A to the end-user.

FIG. 6 is a block diagram of a network system 2500 comprising a collection of computer networks connected to a plurality of nodes. The nodes are typically general-purpose computers comprising a source node S, an end node N, a destination node D and a plurality of intermediate nodes or routers R1 and R2. Each node typically comprises a central processing unit (CPU) 2502, a memory unit 2504 and at least one network adapter 2506 interconnected by a system bus 2510. The memory unit 2504 may comprise storage locations typically composed of random access memory (RAM) devices, which are addressable by the CPU 2502 and network adapter 2506. The memory unit typically provides temporary storage of information, such as, for example, executable processes and contents of data packets, as described further herein. An operating system, portions of which are typically resident in memory and executed by CPU, functionally organizes the node by, inter alia, invoking network operations in support of those processes executing in the CPU.

The computer networks included within system 2500 may range from local area networks (LANs) to wide area networks (WANs). A LAN is a limited area network, while a WAN may be a public or private telecommunications facility that interconnects nodes widely dispersed using communication links. Communication among the nodes coupled to these networks is typically effected by exchanging discrete data “packets” specifying addresses of, e.g., source and destination nodes. Since the system shown in FIG. 25 comprises a relatively small group of interconnected LANs 1-3, it is typically maintained as an autonomous domain. The intermediate nodes, typically routers, are configured to facilitate the flow of data packets throughout the domain 2500 by routing those packets to the proper receiving nodes.

In general, when a source node S transmits a packet over LAN 1, the packet is sent to all nodes on that LAN. If the intended recipient of the packet is connected to LAN 3, the packet is routed through router R1, over LAN 2 and through R2 onto LAN 3. A key function of a router is determining the next node to which the packet is sent; this routing function is typically performed by network layer 2560 of a protocol stack 2550 within each node. Typically, the packet includes two destination addresses: the address of the final destination node and the address of the next node along the route. The final destination address remains constant as the packet traverses the networks along an optimal route, while the next destination address changes as the packet moves from node to node along the optimal route through the networks.

Specifically, when source node S sends a packet to destination node D, i.e., the final destination address, the packet is transmitted onto LAN 1 with a next destination address specifying the address of router R1. Address information embedded in the packet, which is processed by the higher-layer software of the protocol stack 2550, identifies the final destination of the packet as node D. Based on this information, R1 determines that the next node along the optimal path is router R2 and proceeds to pass the packet onto LAN 2 for reception by that node. Router R2 then determines that the next node is the final destination node D and transmits the packet over LAN 3 to node D.

FIGS. 7A and 7B illustrate a computer system 2600 suitable for implementing embodiments of the present invention. FIG. 7 shows one possible physical form of the computer system. Of course, the computer system may have many physical forms ranging from an integrated circuit, a printed circuit board and a small handheld device up to a huge super computer. Computer system 2600 includes a monitor 2602, a display 2604, a housing 2606, a disk drive 2608, a keyboard 2610 and a mouse 2612. Disk 2614 is a computer-readable medium used to transfer data to and from computer system 2600.

FIG. 7B is an example of a block diagram for computer system 2600. Attached to system bus 2620 are a wide variety of subsystems. Processor(s) 2622 (also referred to as central processing units, or CPUs) are coupled to storage devices including memory 2624. Memory 2624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 2626 is also coupled bi-directionally to CPU 2622; it provides additional data storage capacity and may also include any of the computer-readable media described below. Fixed disk 2626 may be used to store programs, data and the like and is typically a secondary storage medium (such as a hard disk) that is slower than primary storage. It will be appreciated that the information retained within fixed disk 2626, may, in appropriate cases, be incorporated in standard fashion as virtual memory in memory 2624. Removable disk 2614 may take the form of any of the computer-readable media described below.

CPU 2622 is also coupled to a variety of input/output devices such as display 2604, keyboard 2610, mouse 2612 and speakers 2630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 2622 optionally may be coupled to another computer or telecommunications network using network interface 2640. With such a network interface, it is contemplated that the CPU might receive information from the network, or might output information to the network in the course of performing the above-described method steps. Furthermore, method embodiments of the present invention may execute solely upon CPU 2622 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

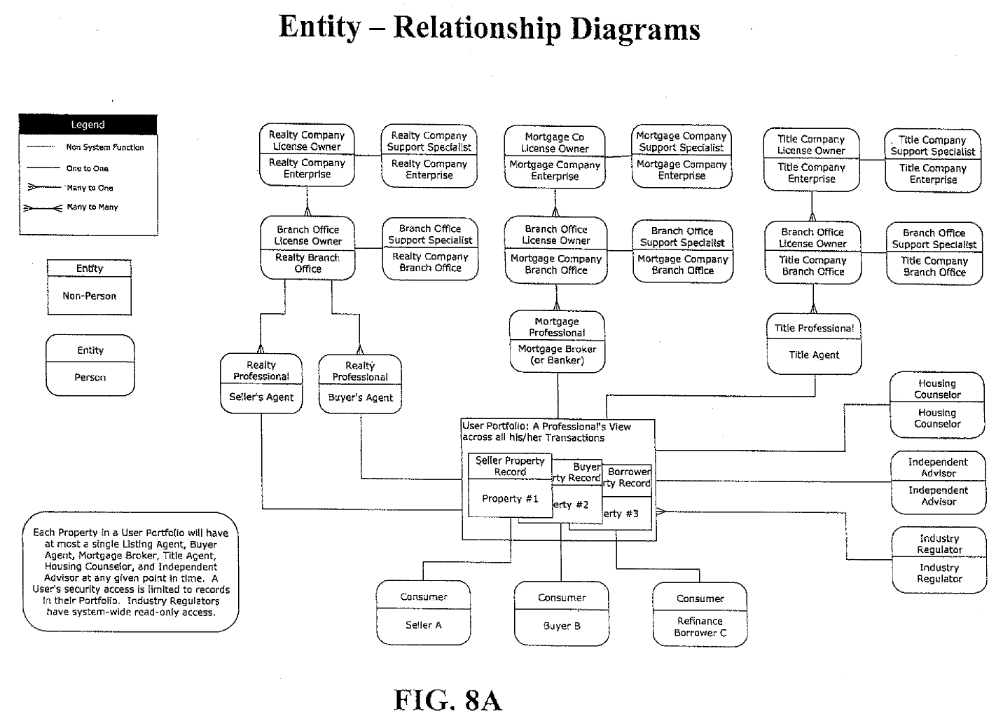

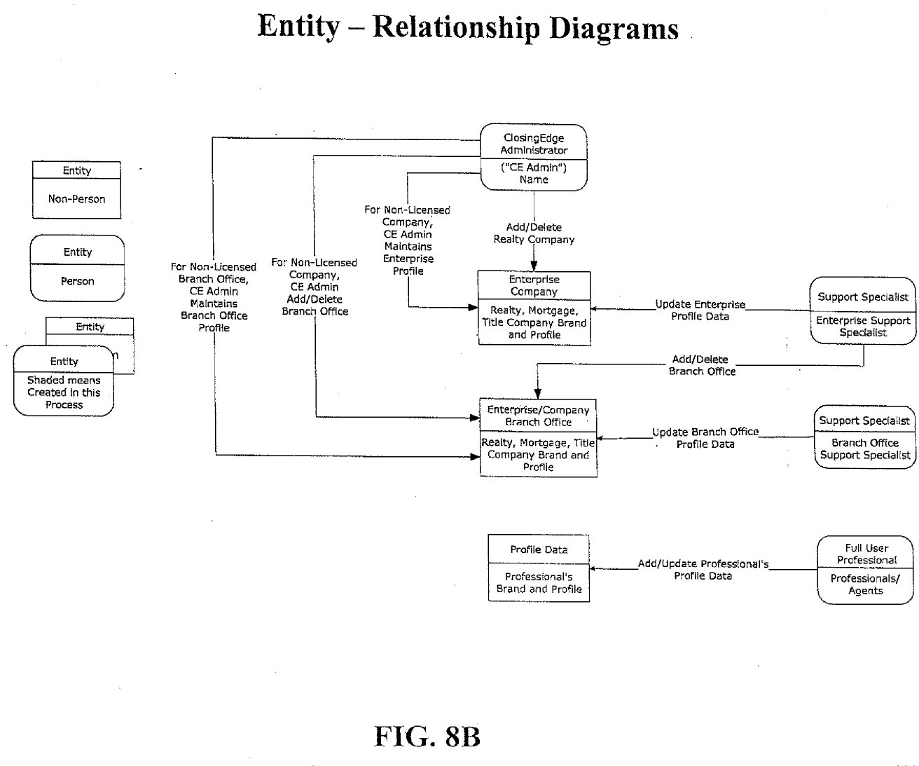

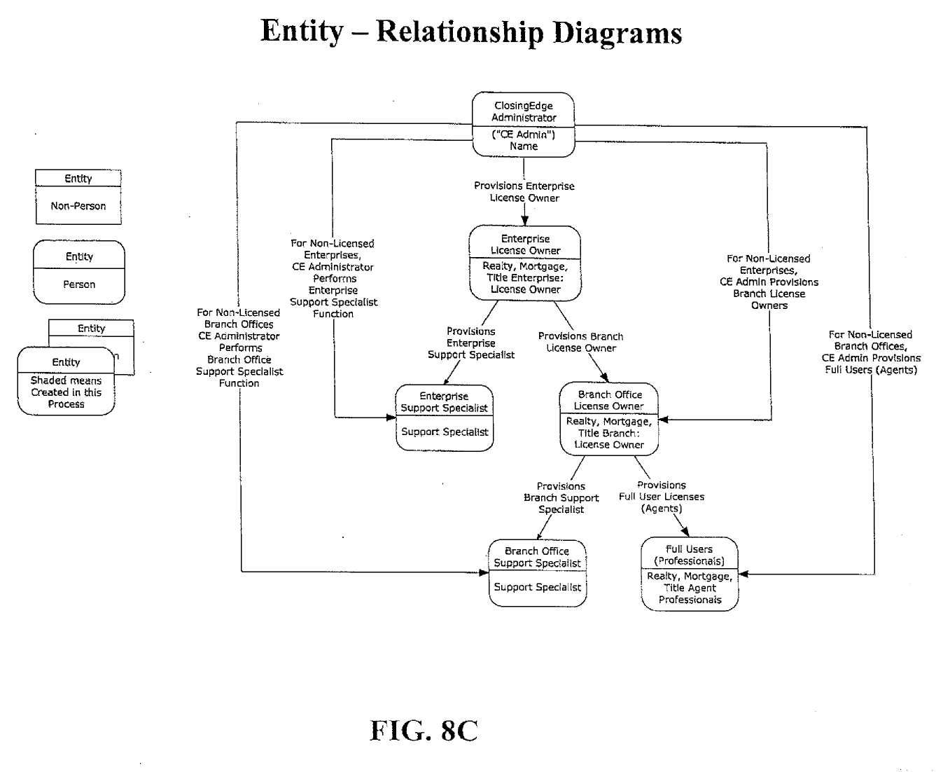

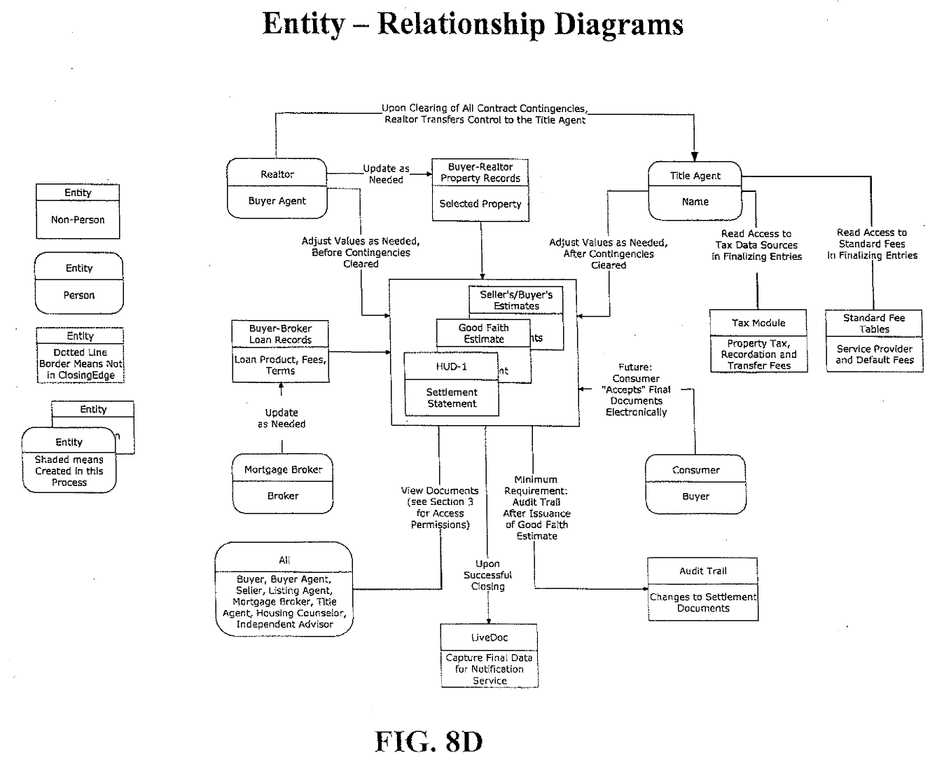

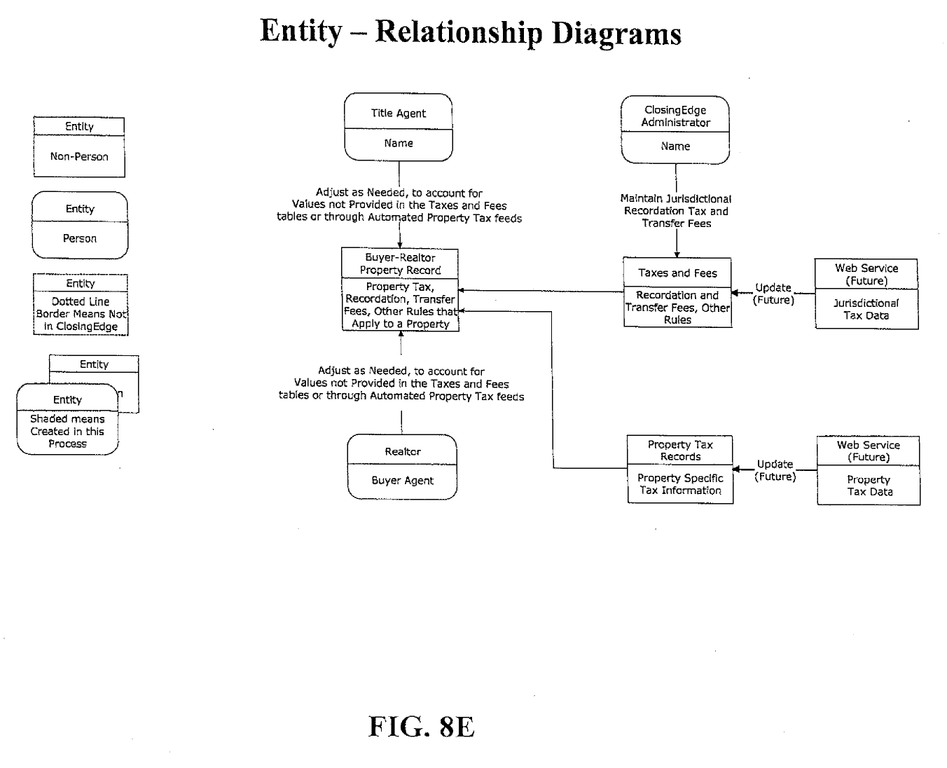

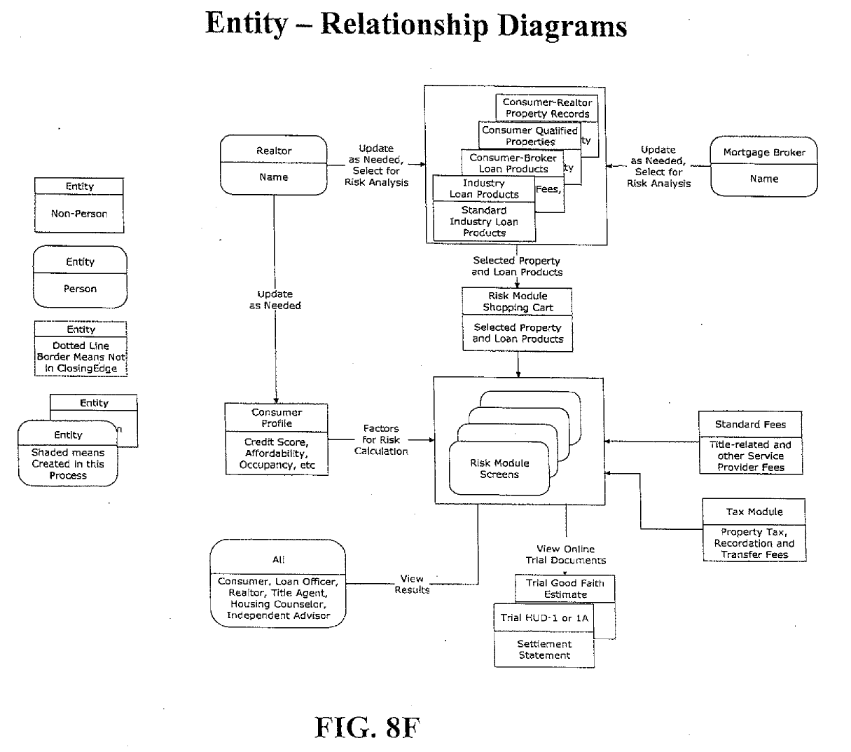

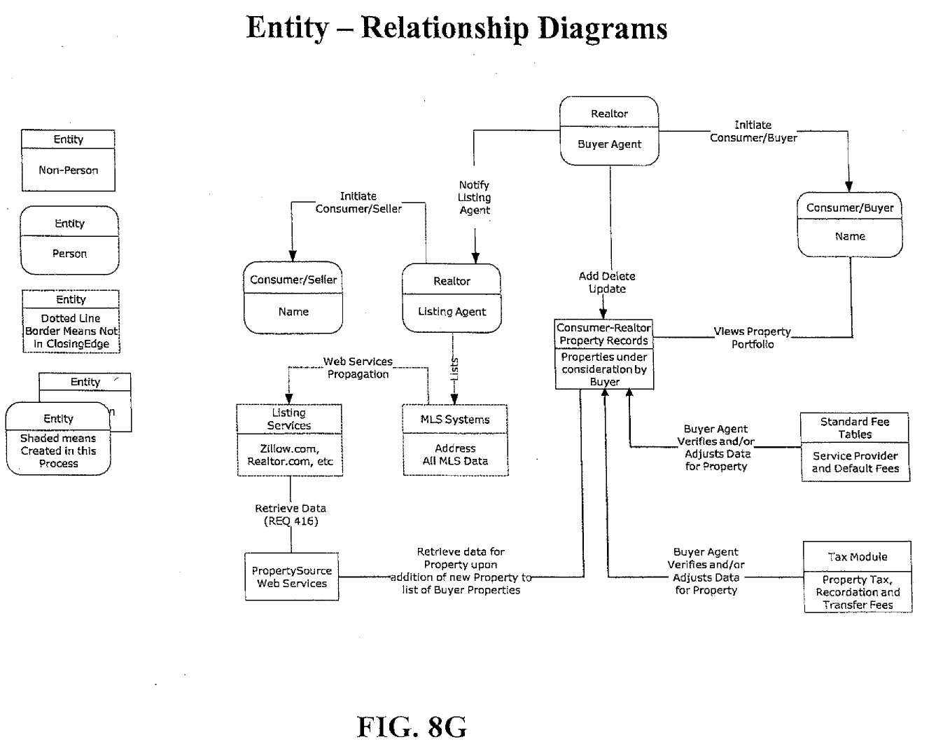

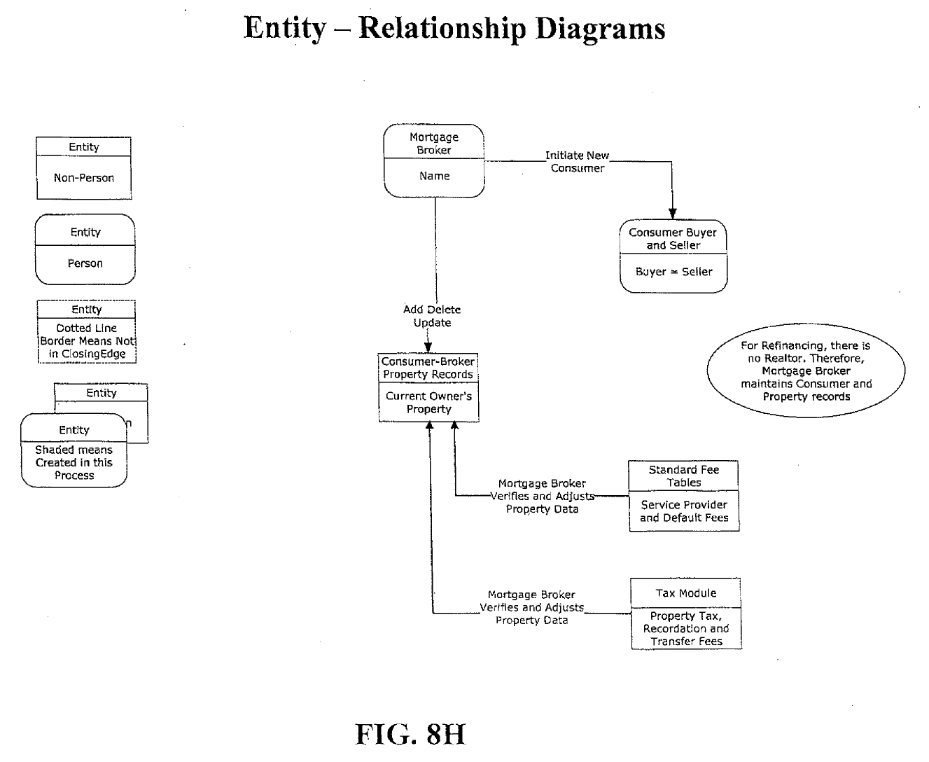

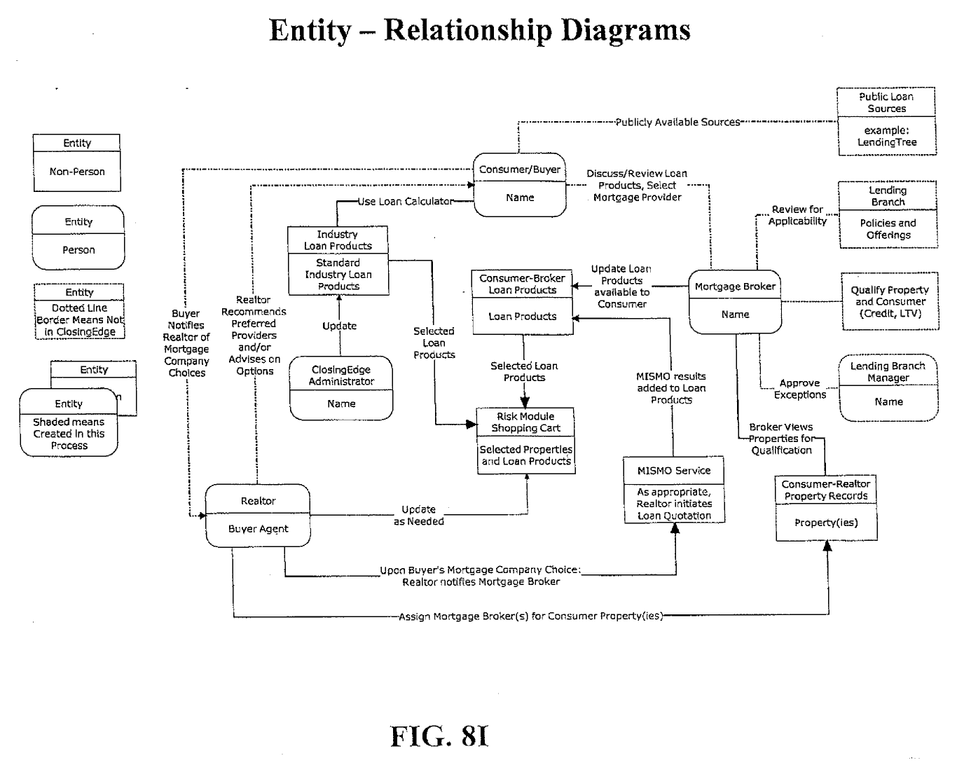

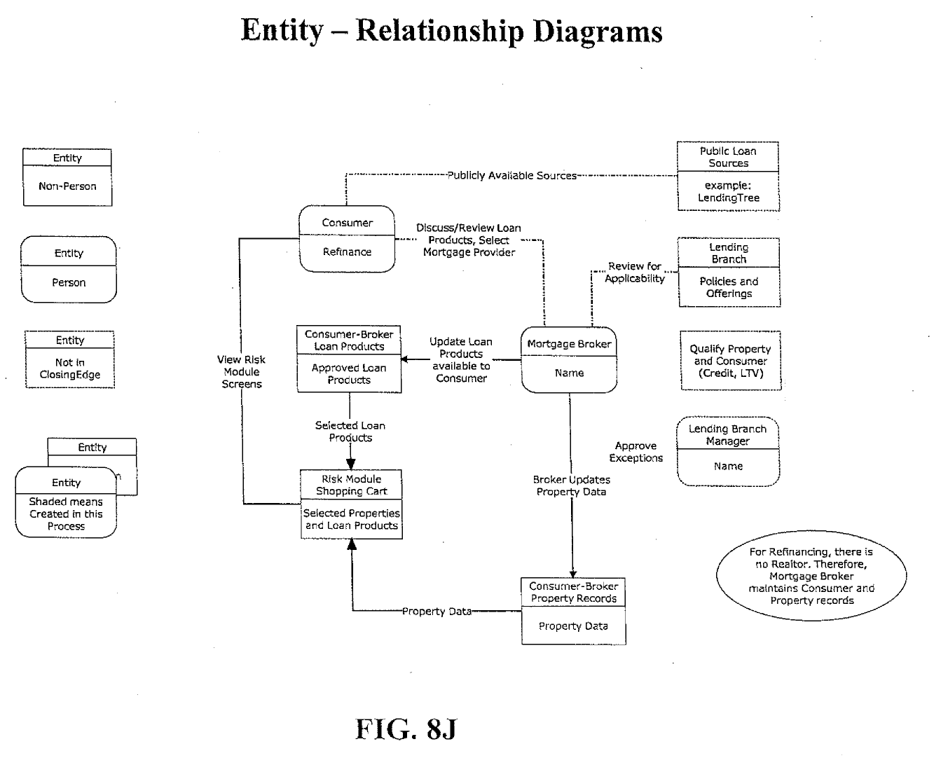

FIGS. 8A to 8J relate to describe the system architecture and relationship diagram of each module and data or information portal or node of the invention. This figure describes the users and all inputs that are converted into fully actionable intelligence relating to the actual closing costs of a specific real estate transaction. The figure describes the users having real time access to the modules of the invention and include but are not limited to customers, e.g. borrowers, where the software determines and delivers the accurate cost of buying the home as early in the process as possible (preferably upon identification of a piece of property of interest); agents, brokers and other real estate professionals, where the software can compile inputted fees and other information for delivery to the consumer or the agent, broker or other professional, on behalf of the consumer; and seller, where the system can determine the exact fees involved and payments involved in various options to utilize full service or discount brokers to maximize a return on investment.

While the invention has been particularly shown and described with reference to specific embodiments thereof, it will be understood by those skilled in the art that changes in the form and details of the disclosed embodiments may be made without departing from the spirit or scope of the invention. For example, although specific embodiments have been described with reference to residential real estate transactions, it will be understood that the techniques of the present invention may be applied to any type of real estate transaction including commercial real estate transactions. Therefore, the scope of the invention should be determined with reference to the appended claims.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

### COPYRIGHT NOTICE

A portion of the disclosure of this patent document may contain material that is subject to copyright protection. The copyright seller has no objection to the facsimile reproduction by anyone of the patent document or the patent disclosure, as it appears in the Patent and Trademark Office patent file or records, but otherwise reserves all copyright rights whatsoever.

1. A computer-implemented method for cohering real estate transaction costs prior to initiation of an application for financing to calculate an end of transaction true cost comprising: creating an integrator portal for real estate transaction data from a plurality of private and proprietary real estate resources; accessing said plurality of private and proprietary real estate resources by a server hosting said integrator portal; linking the real estate transaction data to said integrated portal in real-time; aggregating real estate cost data based on a pre-determined property input and a consumer specific background input; and calculating a true cost associated with the real estate transaction from said cost data, wherein the cost associated with said transaction is delivered to a user.

2. The computer-implemented method of claim 1 further comprising admitting said user to said integrator portal.

3. The computer-implemented method of claim 1 further comprising providing said user real time access to said integrator portal.

4. The computer-implemented method of claim 1, wherein said user is selected from the group consisting of: consumers, real estate professionals, title professionals and mortgage professionals.

5. The computer-implemented method of claim 1, wherein said plurality of private and proprietary real estate resources comprises lender organizations, banker organizations, settlement organizations; title companies; appraisers; regulatory and legislative databases; and real estate listing aggregators.

6. A computer system for cohering real estate transaction costs prior to initiation of an application for financing to calculate an end of transaction true cost comprising: an integrator adapted to collecting real estate transaction data from a plurality of private and proprietary real estate resources; accessor module for interconnecting said plurality of private and proprietary real estate resources with a server hosting said integrator; an aggregator adapted to selectively compile real estate cost data based on a pre-determined property input and a consumer specific background input; and a calculator adapted to compute a true cost associated with the real estate transaction from said cost data, and a graphic user interface adapted to deliver real estate transaction information to a user.

7. The computer system of claim 6, wherein said integrator provides for real time access.

8. The computer system of claim 6, wherein said user is selected from the group consisting of: consumers, real estate professionals, title professionals and mortgage professionals.

9. The computer system of claim 6, wherein said plurality of private and proprietary real estate resources comprises lender organizations, banker organizations, settlement organizations; title companies; appraisers; regulatory and legislative databases; and real estate listing aggregators.

10. A computer program product for cohering real estate transaction costs prior to initiation of an application for financing to calculate an end of transaction true cost comprising: creating an integrator portal for real estate transaction data from a plurality of private and proprietary real estate resources; accessing said plurality of private and proprietary real estate resources by a server hosting said integrator portal; linking the real estate transaction data to said integrated portal in real-time; aggregating real estate cost data based on a pre-determined property input and a consumer specific background input; and calculating a true cost associated with the real estate transaction from said cost data, wherein the cost associated with said transaction is delivered to a user.

11. The computer program product of claim 10 further comprising admitting said user to said integrator portal.

12. The computer program product of claim 10 further comprising providing said user real time access to said integrator portal.

13. The computer program product of claim 10, wherein said user is selected from the group consisting of: consumers, real estate professionals, title professionals and mortgage professionals.

14. The computer program product of claim 10, wherein said plurality of private and proprietary real estate resources comprises lender organizations, banker organizations, settlement organizations; title companies; appraisers; regulatory and legislative databases; and real estate listing aggregators.

15. A computer-implemented method for cohering real estate transaction costs prior to initiation of an application for financing to calculate an end of transaction true cost comprising: provides a hub or, alternately an integrator network, for various real estate transaction related functions including search of property, origination, processing, funding an closing of mortgage financing.

16. The computer-implemented method of claim 15 comprising: providing for real-time updating of information from a plurality of real estate informational resources including but not limited to: title companies and appraisers, wherein the fee information regarding historical transactions and current valuation of the property is maintained; integrating search and informational capabilities from public and private real estate related web-sites; regulatory and legislative information, wherein the system searches through federal and state government and private regulatory and legislative web-sites to compile compliance issues and transparent processes related to determining fees; inquiring the fees for various loan products and settlement services fees where the system automatically processes to update the data related to various fees from third party data stores or contracted services.

17. The computer-implemented method of claim 15 wherein the users have real time access to the hub or integrator system of the invention which includes customers, wherein the software determines and delivers the accurate cost of buying.

18. The computer-implemented method of claim 15 wherein the system compile inputted fees and other information for delivery to the consumer from a agent, broker or other professional on behalf of the consumer.

19. The computer-implemented method of claim 15, wherein a seller determines the exact fees involved and payments involved in various options to utilize full service or discount brokers to maximize a return on investment.
